(19) United States
(12) Patent Application Publication
(10) Pub. No.: US 2012/0194810 A1
(43) Pub. Date: Aug. 2, 2012

(54) Apparatus for inspecting printed circuit board

(75) Inventors: Taeg Gyum Kim, Yongin (KR); Jae Youn Jeong, Yongin (KR)

(73) Assignee: SAMSUNG ELECTRO-MECHANICS CO., LTD., Suwon (KR)

(21) Appl. No.: 13/064,503

(22) Filed: Mar. 29, 2011

(30) Foreign Application Priority Data
Jan. 28, 2011 (KR) 10-2011-0008791

(51) Int. Cl. G01N 21/88

(52) U.S. Cl. 356/237.5

(57) ABSTRACT

Disclosed herein is an apparatus for inspecting a printed circuit board. The apparatus includes a first laser light source; a first light condensing unit condensing a light emitted from the first laser light source onto a printed circuit board having a via-hole; a first dichroic beam splitting unit separating fluorescent light a fluorescence generated from the printed circuit board by the light condensed by the first light condensing unit from the light emitted from the first laser light source; and a determining unit determining an unplated state of the printed circuit board from the light passing through the first dichroic beam splitting unit, wherein the via-hole formed in the printed circuit board includes an internal side surface having an unplated part which is not plated, and the light emitted from the first light condensing unit is incident at a first angle with respect to the printed circuit board and condensed to the unplated part of the internal side surface of the via-hole. Through this apparatus, the defects of the printed circuit board can be promptly determined.

### CROSS-REFERENCE TO RELATED APPLICATIONS

This application claims the priority of Korean Patent Application No. 10-2011-0008791 filed on Jan. 28, 2011, in the Korean Intellectual Property Office, the disclosure of which is incorporated herein by reference.

### BACKGROUND OF THE INVENTION

1. Field of the Invention

The present invention relates to an apparatus for inspecting a printed circuit board, and more particularly, to an apparatus for inspecting a printed circuit board capable of inspecting an unplated part of a via hole formed in the printed circuit board.

2. Description of the Related Art

In general, a printed circuit board having a multi-layer structure is formed by laminating a plurality of unit printed circuit board and connecting circuit patterns, respectively formed thereon, to each other through contacts or via-holes. FIG. 1 shows a process of laminating a plurality of these unit printed circuit boards and then forming a via hole between the circuit patterns of the laminated unit printed circuit boards.

Referring to FIG. 1, a printed circuit board 100 is prepared by laminating a plurality of unit printed circuit boards each having a copper pattern c formed on a resin layer r. A via-hole v is then formed in the prepared printed circuit board 100 by using a laser process. A printed circuit board 101 has the via-hole v formed therein by the laser process. A metal plating treatment is then performed on the via-hole v to connect upper and lower unit printed circuit board patterns to each other (see, a reference numeral 102). However, as a diameter of the via-hole v is gradually decreased and a depth of the via-hole v is gradually increased, particularly in a case in which the via-hole v has a diameter of 100 μm or less and a depth of 100 μm or more, a plating liquid may not sufficiently circulated to an inside of the via-hole v, resulting in an unplated part X (see, a reference number 103). This unplated part X may cause the printed circuit board to be defective.

### SUMMARY OF THE INVENTION

The present invention provides an apparatus for inspecting a print circuit board capable of inspecting an unplated part of an internal side surface of via-hole formed in the printed circuit board at a high speed.

According to an aspect of the present invention, there is provided an apparatus for inspecting a printed circuit board, the apparatus including: a first laser light source; a first light condensing unit condensing light emitted from the first laser light source onto a printed circuit board having a via-hole; a first dichroic beam splitting unit separating fluorescent light generated from the printed circuit board by the light condensed by the first light condensing unit from the light emitted from the first laser light source; and a determining unit determining an unplated state of the printed circuit board from the light passing through the first dichroic beam splitting unit, wherein the via-hole formed in the printed circuit board includes an internal side surface having an unplated part which is not plated, and the light emitted from the first light condensing unit is incident at a first angle with respect to the printed circuit board and condensed to the unplated part of the internal side surface of the via-hole.

The first angle may be more than 0° and less than 90°.

The first light condensing unit may condense the light emitted from the first laser light source in a first direction of one side surface of the printed circuit board.

The apparatus may further includes an X-Y stage fixing the printed circuit board thereto and moving the printed circuit board in a second direction perpendicular to the first direction.

The first light condensing unit may include one of a galvano-mirror, a polygon mirror, a resonant scanner, or an acoustic-optic deflector (AOD).

The apparatus may further include a fluorescent filter allowing only light having a specific wavelength, inputted to the determining unit, to pass therethrough.

The first dichroic beam splitting unit may include a dichroic mirror.

The determining unit may include one of a photodiode or a photomultiplier (PMT).

The apparatus may further includes: a second laser light source; second light condensing unit condensing light emitted from the second laser light source onto the printed circuit board; and second dichroic beam splitting unit separating fluorescent light generated from the printed circuit board by the light condensed by the second light condensing unit from the light emitted from the second laser light source, wherein the determining unit determines the unplated state of the printed circuit board from the light passing through the second dichroic beam splitting unit, the light emitted from the second light condensing unit is incident at a second angle with respect to the printed circuit board, while being incident in a direction opposite to the light emitted from the first light condensing unit, and the light emitted from the second light condensing unit is condensed onto an unplated part of another internal side surface opposite to the internal side surface of the via-hole onto which the light is condensed by the first light condensing unit.

The second angle may be more than 0° and less than 90°.

The second light condensing unit may condense the light emitted from the second laser light source in a first direction of one side surface of the printed circuit board.

The apparatus may further includes an X-Y stage fixing the printed circuit board thereto and moving the printed circuit board in a second direction perpendicular to the first direction.

The second light condensing unit may include one of a galvano-mirror, a polygon mirror, a resonant scanner, or an acoustic-optic deflector (AOD).

The apparatus may further include a fluorescent filter allowing only light having a specific wavelength, inputted to the determining unit, to pass therethrough.

The second dichroic beam splitting unit may include a dichroic mirror.

The determining unit may include one of a photodiode or a Photomultiplier (PMT).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 shows a process of forming a via-hole between patterns of laminated unit printed circuit boards according to the related art;

FIG. 2 shows an apparatus for inspecting a printed circuit board according to an embodiment of the present invention;

FIG. 3 is a side cross-sectional view showing a side surface of a via-hole according to an embodiment of the present invention;

FIG. 4 shows light condensed in a first direction of a printed circuit board and an X-Y stage moving along a second direction of the printed circuit board according to an embodiment of the present invention; and

FIG. 5 shows an apparatus for inspecting a printed circuit board according to another embodiment of the present invention.

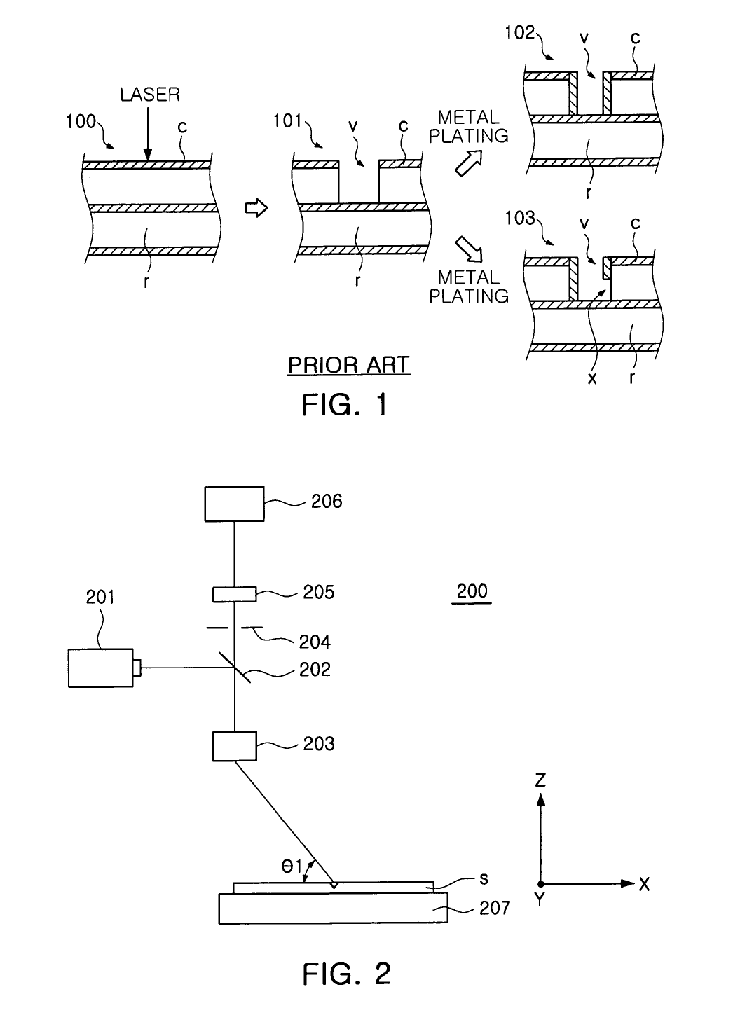

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments may be provided so that this disclosure will be thorough and complete, and will fully convey the scope of the invention to those skilled in the art. In the drawings, the shapes and sizes of components are exaggerated for clarity.

Hereinafter, the preferred embodiments of the present invention will be described in detail with reference to the accompanying drawings.

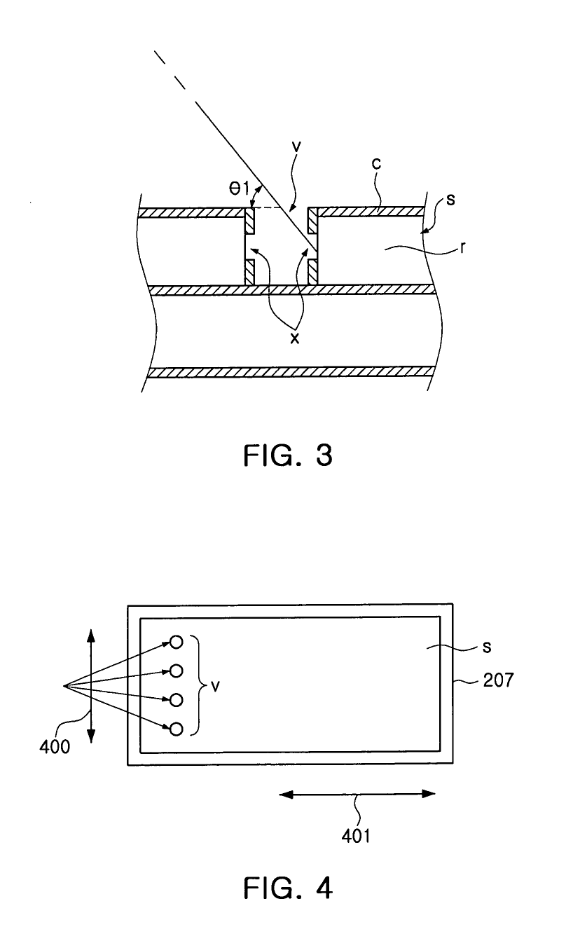

FIG. 2 shows an apparatus for inspecting a printed circuit board according to an embodiment of the present invention; FIG. 3 is a side cross-sectional view showing a side surface of a via-hole according to an embodiment of the present invention; and FIG. 4 shows light condensed in a first direction of a printed circuit board and an X-Y stage moving along a second direction of the printed circuit board according to an embodiment of the present invention.

An apparatus 200 for inspecting a printed circuit board according to an embodiment of the present invention includes a first laser light source 201, a first light condensing unit 203 condensing light emitted from the first laser light source 201 onto a printed circuit board S, a first dichroic beam splitting unit 202 separating fluorescent light generated from the printed circuit board by the light condensed by the first light condensing unit 203 from the light emitted from the first laser light source 201, and a determining unit 206 determining the unplated state of the printed circuit board S by the light passing through the first dichroic beam splitting unit 202. An internal side surface of the via-hole v formed in the printed circuit board S may include an unplated part X that is not plated. The light emitted from the first light condensing unit 203 may be incident at a first angle θ1 with respect to the printed circuit board S, and condensed onto the unplated part X of the internal side surface of the via-hole v.

Hereinafter, an apparatus 200 for inspecting a printed circuit board according to an embodiment of the present invention will be described in detail with reference to FIGS. 2 through FIG. 4.

The first laser light source 201 is a general laser source for emitting laser light. In the printed circuit board S, while a part that is plated with metal does not generate the fluorescent light by receipt of the laser light, a part that is not plated with metal, that is, a resin portion generates the fluorescent light by receipt of the laser light. This fact may be used in the present invention. A laser having a short wavelength, such as ultraviolet rays (W), may be used in order to improve the efficiency of the fluorescence.

The first light condensing unit 203 condenses the light emitted from the first laser light source 201 onto the printed circuit board S, while at the same time transmitting the fluorescent light generated from the printed circuit board s by the light to the first dichroic beam splitting unit 202. The first light condensing unit 203 may include one of a galvano-mirror, a polygon mirror, a resonant scanner, or an acoustic optic deflector (AOD). Meanwhile, according to an exemplary embodiment of the present invention, the first light condensing unit 203 is capable of increasing the rate at which the unplated state is determined, by moving the light in a first direction 400 of one side surface of the printed circuit board at a high speed, as shown in FIG. 4.

The first dichroic beam splitting unit 202 performs separating the fluorescent light generated from the printed circuit board S by the light condensed by the first light condensing unit 203 from the light emitted from the first laser light source 201. More specially, the first dichroic beam splitting unit 202 reflects the light emitted from the first laser light source 201, and passes the fluorescent light generated from the printed circuit board S, as it is. This first dichroic beam splitting unit 202 may include a dichroic mirror.

A pin hole 204 is installed between the first dichroic beam splitting unit 202 and a fluorescent filter 205 to perform blocking unnecessary information regarding the fluorescent light passing through the first dichroic beam splitting unit 202.

The fluorescent filter 205 is installed between the determining unit 206 and the pin hole 204 to pass only the light having a specific wavelength which is inputted to the determining unit 206. The fluorescent light passing through the fluorescent filter 205 is inputted to the determining unit 206.

The determining unit 206 performs determining the unplated state of the via-hole v formed in the printed circuit board S by the fluorescent light having passed through the fluorescent filter 205. This determining unit 206 may include a photomultiplier (PMT) when the fluorescent light generated from the printed circuit board S is weak, and may include a photodiode when the fluorescent light generated from the printed circuit board S is sufficiently strong.

On the other hand, the X-Y stage 207 may fix the printed circuit board S thereto, and moves in a second direction 401 perpendicular to a scan direction 400 of the first light condensing unit 203. As such, the rate at which the printed circuit board S is scanned may be improved by the first light condensing unit 203 and the X-Y stage 207, thereby increasing the rate at which the unplated state of the via-hole v formed in the printed circuit board S is determined.

Hereinafter, an operational principle of the apparatus 200 for inspecting a printed circuit board according to an embodiment of the present invention will be described in detail with reference to FIGS. 2 through 4.

Referring to FIGS. 2 through 4, the light emitted from the first laser light source 201 is reflected by the first dichroic beam splitting unit 202, and transmitted to the first light condensing unit 203. The first light condensing unit 203, as shown in FIG. 4, condenses the light onto the printed circuit board S in the first direction 400. Herein, as shown in FIG. 3, the light has a predetermined incident angle θ1 with respect to the printed circuit board S. This incident angle θ1 may lead the light to be condensed to the internal side surface of the via-hole v.

As a result, due to the light condensed onto the unplated part X of the internal side surface of the via-hole v, the fluorescent light is generated from the unplated part X. The generated fluorescent light again passes through the first light condensing unit 203, and then is transmitted to the first dichroic beam splitting unit 202. The first dichroic beam splitting unit 202 passes the fluorescent light. The fluorescent light having passed from the first dichroic beam splitting unit 202 is transmitted to the determining unit 206 through the pin hole 204 and the fluorescent filter 205. The determining unit 206 is capable of determining whether an inside of the via-hole v formed in the printed circuit board s is completely plated or not, according to the presence or absence of the fluorescent light. Meanwhile, the X-Y stage 207 fixing the printed circuit board S thereto moves in the second direction 401 while the first light condensing unit 203 condenses the light in the first direction 400, thereby further improving the rate of inspection.

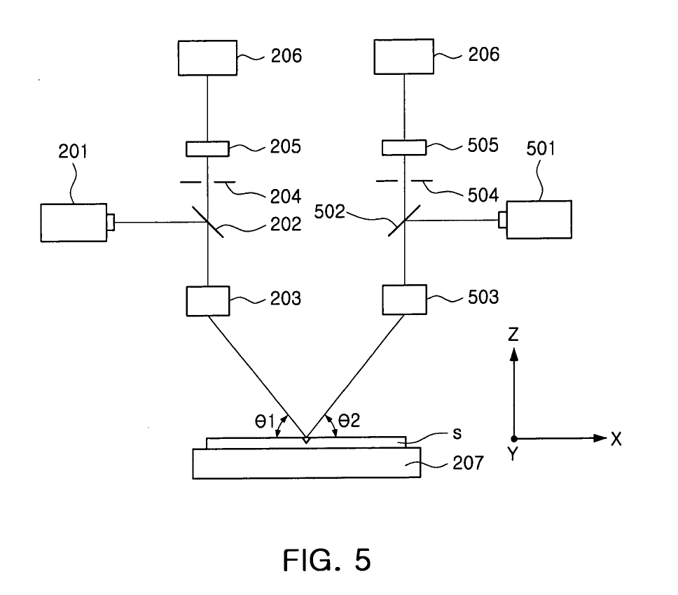

FIG. 5 shows an apparatus for inspecting a printed circuit board according to another preferred embodiment of the present invention. According to this embodiment, the internal side surface of the via-hole v may be more precisely inspected by using two laser lights. When using one laser light as shown in FIG. 3, a precise inspection is impossible because the laser light does not reach an unplated part of another internal side surface opposite to the internal side surface of the via-hole v onto which the laser light is condensed. In order to solve this defect, two laser lights need to reach one via-hole v.

An apparatus for inspecting a printed circuit board according to another preferred embodiment of the present invention, besides components described in FIG. 2, may include a second laser light source 501, a second light condensing unit 503 condensing light emitted from the second laser light source 501 onto the printed circuit board S, a second dichroic beam splitting unit 502 separating fluorescent light generated from the printed circuit board S by the light condensed by the second light condensing unit 503 from the light emitted from the second laser light source 510, a second fluorescent filter 505 allowing only light having a specific wavelength, inputted to the determining unit, to pass therethrough, and a second pin hole 504 blocking unnecessary information between the fluorescent filter 505 and the second dichroic beam splitting unit 502.

An operational principle of the apparatus for inspecting a printed circuit board described with reference with FIG. 5 is similar to that of the apparatus described with reference to FIGS. 2 through 4. In the present embodiment of the present invention, two lights are condensed to the internal side surface of one via-hole v. That is, the light emitted from the second light condensing unit 503 is incident at a second incident angle θ2 with respect to the printed circuit board S, while being incident in a direction opposite to the light emitted from the first light condensing unit 203. Accordingly, the light emitted from the second light condensing unit 503 is condensed onto an unplated part on another internal side surface opposite to the internal side surface of the via-hole v onto which the light is condensed by the first light condensing unit 203. Since the remainder parts are overlapped with the explanation set forth with reference to FIGS. 2 through 4, a detailed description thereof will be omitted.

As set forth above, according to exemplary embodiments of the invention, determining an unplated part of a printed circuit board may be carried out, by using the fact in which a resin portion, the unplated part of the printed circuit board generates fluorescent light when receiving laser light. In addition, according to exemplary embodiments of the invention, determining whether an internal side surface of a via-hole is plated or not, may be carried out, by allowing the light emitted from a laser light source to be incident onto the printed circuit board at a predetermined angle, in order to determine the unplated part of the internal side surface of the via-hole formed in the printed circuit board. On the other hand, according to exemplary embodiments of the invention, determining whether the printed circuit board is defective or not at a high speed, may be carried out, by moving the X-Y stage fixing the light condensing unit and the printed circuit board thereto in a predetermined direction.

The present invention has been shown and described in connection with the exemplary embodiments, but it will be apparent to those skilled in the art that modifications and variations can be made thereto without departing from the spirit and scope of the invention as defined by the appended claims.

1-16. (canceled)

17. An apparatus for inspecting a printed circuit board, comprising:
a first laser light source;
a first light condensing unit condensing light emitted from the first laser light source onto a printed circuit board having a via-hole;
a first dichroic beam splitting unit separating fluorescent light generated from the printed circuit board by the light condensed by the first light condensing unit, from the light emitted from the first laser light source; and
a determining unit determining an unplated state of an internal side surface of the via-hole of the printed circuit board from the fluorescent light passing through the first dichroic beam splitting unit.

18. The apparatus of claim 17, wherein the fluorescent light is generated from resin of an unplated part formed on the internal side surface of the via-hole of the printed circuit board.

19. The apparatus of claim 18, wherein the determining unit determines the unplated state of the internal side surface of the via-hole from the fluorescent light passing through the first dichroic beam splitting unit.

20. The apparatus of claim 17, wherein the light emitted from the first light condensing unit is incident at a first angle with respect to the printed circuit board and condensed onto the unplated part formed on the internal side surface of the via-hole.

21. The apparatus of claim 20, wherein the first angle is greater than 0° and less than 90°.

22. The apparatus of claim 17, wherein the first light condensing unit condenses the light emitted from the first laser light source in a first direction of one side surface of the printed circuit board.

23. The apparatus of claim 22, further comprising an X-Y stage fixing the printed circuit board thereto and moving the printed circuit board in a second direction, perpendicular to the first direction.

24. The apparatus of claim 17, wherein the first light condensing unit includes one of a galvano-mirror, a polygon mirror, a resonant scanner, and an acoustic-optic deflector (AOD).

25. The apparatus of claim 17, further comprising a fluorescent filter allowing only light having a specific wavelength, inputted to the determining unit, to pass therethrough.

26. The apparatus of claim 17, wherein the first dichroic beam splitting unit includes a dichroic mirror.

27. The apparatus of claim 17, wherein the determining unit includes one of a photodiode and a photomultiplier (PMT).

28. The apparatus of claim 17, further comprising:
a second laser light source;
a second light condensing unit condensing light emitted from the second laser light source onto the printed circuit board; and
a second dichroic beam splitting unit separating fluorescent light generated from the printed circuit board by the light condensed by the second light condensing unit, from the light emitted from the second laser light source,
wherein the determining unit determines the unplated state of the printed circuit board from the fluorescent light passing through the second dichroic beam splitting unit, and the light emitted from the second light condensing unit is incident at a second angle with respect to the printed circuit board, while being incident in a direction opposite to the light emitted from the first light condensing unit.

29. The apparatus of claim 28, wherein the light emitted from the first light condensing unit is incident at a first angle with respect to the printed circuit board and condensed onto the unplated part formed on the internal side surface of the via-hole, and the light emitted from the second light condensing unit is condensed onto an unplated part of another internal side surface opposite to the internal side surface of the via-hole onto which the light is condensed by the first light condensing unit.

30. The apparatus of claim 28, wherein the second angle is greater than 0° and less than 90°.

31. The apparatus of claim 28, wherein the second light condensing unit includes one of a galvano-mirror, a polygon mirror, a resonant scanner, and an acoustic-optic deflector (AOD).

32. The apparatus of claim 28, wherein the second dichroic beam splitting unit includes a dichroic mirror.

33. An apparatus for inspecting a printed circuit board, comprising:
a first laser light source;
a first light condensing unit condensing light emitted from the first laser light source onto a printed circuit board having a via-hole;
a first dichroic beam splitting unit separating fluorescent light generated from resin of an unplated part of the printed circuit board by the light condensed by the first light condensing unit, from the light emitted from the first laser light source; and
a determining unit determining an unplated state of the printed circuit board from the fluorescent light passing through the first dichroic beam splitting unit.

34. The apparatus of claim 33, wherein the unplated part is formed on an internal side surface of the via-hole of printed circuit board.

35. The apparatus of claim 34, wherein the determining unit determines the unplated state of the internal side surface of the via-hole, from the fluorescent light generated from the resin of the unplated part formed on the internal side surface of the via-hole of the printed circuit board and passing through the first dichroic beam splitting unit.

36. An apparatus for inspecting a printed circuit board, comprising:
a first laser light source;
a first light condensing unit condensing light emitted from the first laser light source onto an unplated part formed on an internal side surface of a via-hole of a printed circuit board;
a first dichroic beam splitting unit separating fluorescent light generated from resin of the unplated part formed on the internal side surface of the via-hole by the light condensed by the first light condensing unit, from the light emitted from the first laser light source; and
a determining unit determining an unplated state of the internal side surface of the via-hole from the fluorescent light passing through the first dichroic beam splitting unit.
